(19) United States
(12) Patent Application Publication
(10) Pub. No.: US 2015/0235619 A1
(43) Pub. Date: Aug. 20, 2015

(54) METHOD OF DRIVING LIGHT SOURCE MODULE AND DISPLAY DEVICE USING THE METHOD

(71) Applicant: Samsung Display Co., Ltd., Yongin-City (KR)

(72) Inventors: Dong Min YEO, Asan-si (KR); Hee Kwang SONG, Suwon-si (KR)

(21) Appl. No.: 14/314,500

(22) Filed: Jun. 25, 2014

(30) Foreign Application Priority Data
Feb. 18, 2014 (US) 10-2014-0018644

(51) Int. Cl. G09G 5/10

(52) U.S. Cl. CPC G09G 5/10

(57) ABSTRACT

A display device includes: a light source module which includes a plurality of light-emitting blocks; a display panel which includes a plurality of pixels and is divided into a plurality of image blocks corresponding to the light-emitting blocks; a light source module control unit which divides an image signal into the image blocks, generates a color dimming signal corresponding to a first image block among the image blocks, obtains pixel distortion values and pixel improvement values corresponding to each pixel of the first image block by analyzing the first image block, determines whether to perform color dimming or not on a driving signal of a first light-emitting block corresponding to the first image block based on the pixel distortion values and the pixel improvement values, and drives the first light-emitting block based on the determination result.

This application claims priority from Korean Patent Application No. 10-2014-0018644 filed on Feb. 18, 2014 in the Korean Intellectual Property Office, the disclosure of which application is incorporated herein by reference in its entirety.

### BACKGROUND

1. Field of Disclosure

The present invention relates to a method of driving a light source module and a display device using the method.

2. Description of Related Technology

Flat or otherwise thin panel displays (FOOT-PDs), such as liquid crystal displays (LCDs), plasma display panels (PDPs) and organic light-emitting diodes displays (OLEDs), are being rapidly developed to replace cathode ray tubes (CRTs). Of the FOOT-PDs, the LCD class as an example and to be contrasted to the PDP class, cannot originate the image light that they emit by themselves. Thus, LCDs and the like require an external light source. Here, the light source may be a points-format light source such as a matrix of light-emitting diodes (LEDs) or a linear-format light source such as an electroluminescent lamp (EL) or a cold cathode fluorescent lamp (CCFL). In particular, LEDs are being widely used as the light sources of choice for providing backlighting (from a corresponding backlight unit) to the LCD panel. The LEDs based backlight unit may be structured to provide merely a uniform white light across an entire display area (DA), or alternatively to selectively provide colored light source points that can be individually controlled on a colored point source by colored point source basis.

Recently, interest in so-called, selective dimming technologies has significantly increased in order to improve contrast ratio and/or reduce power consumption of products employing a backlight unit that uses LEDs as point light sources. In one class of such dimming approaches, the entire screen display area (DA) is divided into a plurality of multi-pixel blocks of equal sizes, and the total (e.g., or normalized average) luminance of each respective block is controlled by way of “luminance dimming” where the latter is performed on a block by block basis to correct for luminance problems such as gamma curve distortion where the latter may be caused, for example, by a leakage of uncontrolled light that somehow passes through the display panel (e.g., by leaking out through areas not controlled by liquid crystals). Accordingly, by use of such “luminance dimming”, a contrast ratio of the display device can be improved, and power consumption by the display device can be advantageously reduced at the same time.

More recently, a combined, luminance and color dimming approach has begun to be explored where backlight dimming is performed on a color-by-color basis in addition to performing it on the basis of luminance alone. More specifically, a technology of employing primary color point sources such as red, green and blue LEDs as light sources and of performing dimming driving according to color as well as according to luminance is being developed. This color-based dimming driving technology can be used to reduce color distortion, for example as determined on a pixel-by-pixel-basis. However, when such determination is made only on a pixel-by-pixel basis, color distortion can occur on a block-by-block basis where each block contains a plurality of pixels of potentially different colors. Therefore, there is still room for improvement when it comes to color display characteristics.

It is to be understood that this background of the technology section is intended to provide useful background for understanding the here disclosed technology and as such, the technology background section may include ideas, concepts or recognitions that were not part of what was known or appreciated by those skilled in the pertinent art prior to corresponding invention dates of subject matter disclosed herein.

### SUMMARY

The present disclosure of invention provides a method of selectively driving a colored light sources module which can improve color reproducibility and reduce color distortion and a display device that automatically uses the method.

However, the present teachings are not restricted to the exemplary embodiments set forth herein. The above and other aspects of the present disclosure will become more apparent to one of ordinary skill in the art to which the present disclosure of invention pertains by referencing the detailed description as given below.

According to an aspect of the present disclosure, there is provided a method of driving a light source module, which provides lights to a display panel having a plurality of pixels and includes a plurality of light-emitting blocks, where the providing of the lights is on a light-emitting block-by-light-emitting block-basis. The method comprises: dividing an image signal into a plurality of image blocks corresponding to the light-emitting blocks by analyzing the image signal, generating a planned color dimming signal which corresponds to a first image block among the image blocks, obtaining a pixel distortion value and a pixel improvement value corresponding to each pixel by analyzing the first image block, determining whether to perform the planned color dimming on a first light-emitting block, which corresponds to the first image block, based on the pixel distortion value and the pixel improvement value, and driving the first light-emitting block based on the determination result.

According to an aspect of the present disclosure of invention, there is provided a display device. The display device comprises: a light source module which comprises a plurality of light-emitting blocks, a display panel which comprises a plurality of pixels and is divided into a plurality of image blocks corresponding to the light-emitting blocks, a light source module control unit which divides an image signal into the image blocks, generates a planned color dimming signal corresponding to a first image block among the image blocks, obtains pixel distortion values and pixel improvement values of a first image block by analyzing all pixels of the first image block, determines whether to perform color dimming on a first light-emitting block corresponding to the first image block based on the pixel distortion values and on the pixel improvement values, and drives the first light-emitting block based on the determination result.

### BRIEF DESCRIPTION OF THE DRAWINGS

The above and other aspects and features of the present disclosure of invention will become more apparent by describing in detail exemplary embodiments thereof with reference to the attached drawings, in which:

FIG. 1 is a schematic block diagram of a display device that is structured in accordance with the present disclosure to provide block-by-block compensation for color distortion caused by color dimming;

FIG. 2 is an exploded apart schematic plan view of a display panel and of a corresponding light source module such as may be used in display device of FIG. 1;

FIG. 3 is a flowchart schematically illustrating a machine-implemented method of automatically driving a light source module according to an embodiment of the present disclosure;

FIG. 4 is a flowchart schematically illustrating an embodiment of operation S30 included in the driving method of FIG. 3;

FIG. 5 is a flowchart schematically illustrating an embodiment of operation S50 included in the driving method of FIG. 3;

FIG. 6 is a flowchart schematically illustrating an embodiment of operation S70 included in the driving method of FIG. 3; and

FIGS. 7 through 16 are diagrams for aiding in the explanation of the driving method of FIG. 3.

### DETAILED DESCRIPTION

Advantages and features of the present disclosure and methods of accomplishing the same may be more readily understood by reference to the following detailed description of exemplary embodiments and the accompanying drawings. The present teachings may, however, be embodied in many different forms and should not be construed as being limited to the exemplary embodiments set forth herein. Rather, these exemplary embodiments are provided so that this disclosure will be thorough and complete and will fully convey the concept(s) of the present disclosure of invention to those skilled in the art. Like numbers refer to like elements throughout. In the drawings, sizes and relative sizes of layers and regions may be exaggerated for clarity.

It will be understood that when an element or layer is referred to as being “on” another element or layer, it can be directly on the other element or layer or intervening elements or layers may be present.

Spatially relative terms, such as “below”, “beneath”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. Like reference numerals refer to like elements throughout the specification.

Embodiments in accordance with the present disclosure of invention are described herein with reference to plan and cross-section illustrations that are schematic illustrations of idealized embodiments. As such, variations from the shapes of the illustrations as a result, for example, of manufacturing techniques and/or tolerances, are to be expected. Thus, embodiments presented herein should not be construed as limiting the teachings to the particular shapes of regions illustrated herein. It is within the contemplation of the disclosure to have deviations in shapes that result, for example, from manufacturing practicalities. Thus, the regions illustrated in the figures are schematic in nature and their shapes are not intended to illustrate the actual shape of a region of a device and are not intended to limit the scope of the present teachings.

It will be understood that, although the terms first, second, third, etc., may be used herein to describe various elements, these elements should not be limited by these terms. These terms are only used to distinguish one element from another element. Thus, a first element discussed below could be termed a second element without departing from the teachings of the invention.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

The suffixes “module” and “unit” for elements used in the following description are given or used in common by considering facilitation in writing this disclosure only but do not have meanings or roles discriminated from each other.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereafter, embodiments of the in accordance with the present disclosure of invention will be described with reference to the attached drawings.

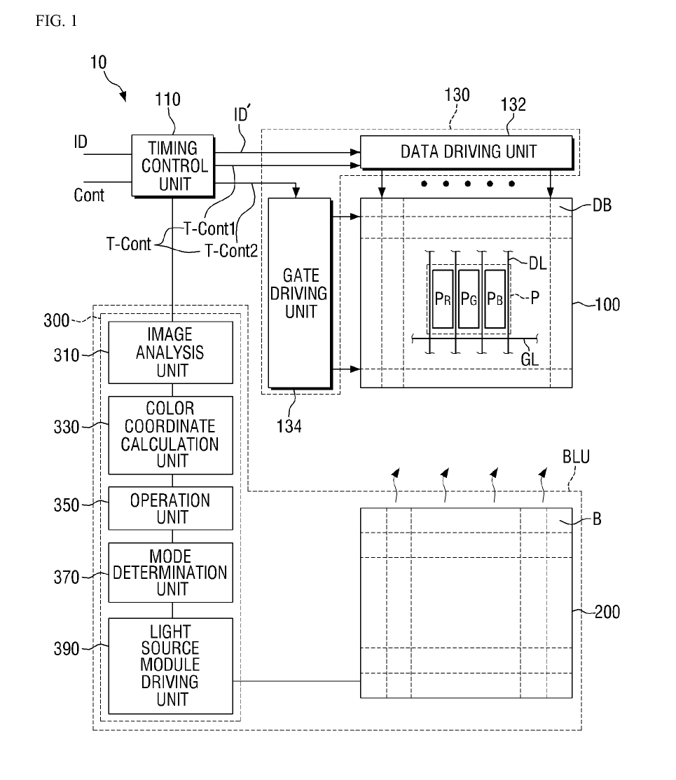

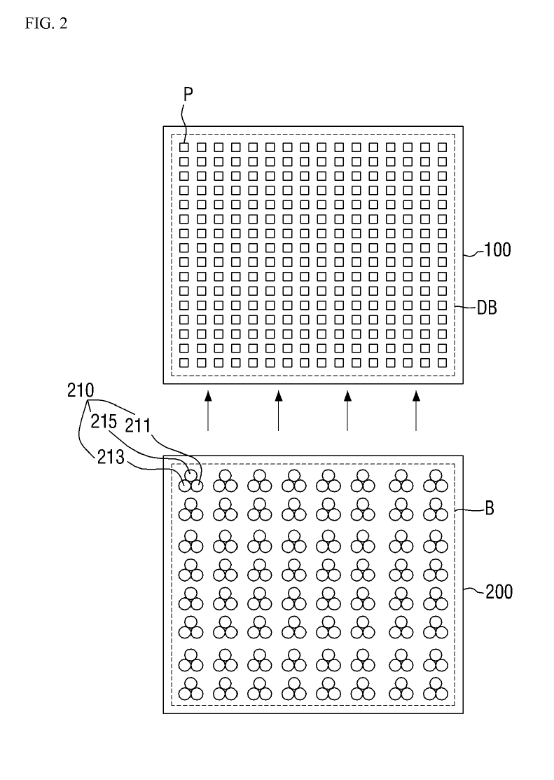

FIG. 1 is a schematic block diagram of a display device 10 according to an embodiment in which the teachings of the present disclosure can be implemented. FIG. 2 is a schematic plan view of an exemplary display panel 100 (e.g., one having a 16×16 array of pixels P designated as a data block DB) and a corresponding light source module 200 (e.g., one having a 8×8 array of RGB emitting triads of LEDs designated as a corresponding light sourcing block B), where the illustrated data block DB and corresponding light sourcing block B can be representative of remaining display area (DA) portions of the panel 100 and of the backlighting module 200 as illustrated in FIG. 1.

Referring to FIG. 1, the display device 10 according; to the current embodiment may include the display panel 100, a timing control unit 110, a panel driving unit 130 and a light sourcing device (backlighting unit or BLU).

The display panel 100 is structured to display an image corresponding to an image representing digital signal ID received from an external source. The display panel 100 may include a plurality of pixels P which are configured to display the image as a color image. Each of the pixels P may include a red subpixel SPr (also referred to as a unit pixel PR), a green subpixel SPg (also referred to as a unit pixel PG), and a blue subpixel SPb (also referred to as a unit pixel PB). Although not illustrated in the drawing, in one embodiment, each of the pixels P may further include a white subpixel SPw (also referred to as a unit pixel PW). Although not illustrated in the drawing, each of the pixels P may include at least one switching element TR which is connected to a corresponding gate line GL and a corresponding data line DL intersecting each other and a liquid crystal capacitor CLC and a storage capacitor CST which are connected to the switching element TR. As will be described later in more detail, the image-forming pixels of the display panel 100 may be grouped into so-called, display panel partitioning blocks, or more simply image display blocks DBs such that the displayed image is divided into a plurality of same-sized image blocks (also referenced as DBs or optionally as iDB's).

The timing control unit 110 receives a control signal Cont and an image signal ID from an external device (not shown). The control signal Cont may include a vertical synchronization signal, a horizontal synchronization signal, a clock signal, a data enable signal, etc. By using the control signal Cont, the timing control unit 110 may generate a timing control signal T_Cont for controlling the driving timing of the panel driving unit 130. The timing control signal T_Cont may include a first control signal T_Cont1 for controlling the driving timing of a data lines driving unit 132 and a second control signal T_Cont2 for controlling the driving timing of a gate lines driving unit 134. The timing control unit 110 may output image data ID′ having a changed data format from that of the input image data ID depending on predetermined interface specifications. The data lines driving unit 132 of the panel driving unit 130 then outputs analog drive signals corresponding to the changed image signal ID′ to the data lines DL of the panel 100. In addition, the timing control unit 110 may output the first control signal T_Cont1 to the data lines driving unit 132 and the second control signal T_Cont2 to the gate lines driving unit 134. In an exemplary embodiment, the first control signal T_Cont1 may include, but is not limited to, an output initiation signal, a horizontal initiation signal, a clock signal, etc. The second control signal T_Cont2 may include, but is not limited to, a vertical initiation signal, a gate clock signal, an output enable signal, etc.

The panel driving unit 130 may drive the display panel 100 using the timing control signal T_Cont and the changed image signal ID′ received from the timing control unit 110. The panel driving unit 130 may include the data lines driving unit 132 and the gate lines driving unit 134.

The gate lines driving unit 134 may receive a gate-on voltage of a predetermined level and a gate-off voltage of a predetermined level and may sequentially output gate line drive signals each having the gate-on voltage present at an assigned time in accordance with the second control signal T_Cont2 received from the timing control unit 110. The gate signals may be sequentially transmitted to activate successive ones of the gate lines GL of the display panel 100 to thereby sequentially scan the gate lines GL. Although not illustrated in the drawing, the display device 10 may further include a power regulator which converts an input voltage into the gate-on voltage and the gate-off voltage and outputs the gate-on voltage and the gate-off voltage to the gate lines driving unit 134.

The data lines driving unit 132 may be operated by an analog driving voltage and may generate a plurality of grayscale voltages using gamma voltages received from a gamma voltage(s) generation unit (not shown). The data lines driving unit 132 may select gray voltages corresponding to the changed image signal ID′ from the generated gray voltages in response to the first control signal T_Cont1 received from the timing control unit 110 and may apply the selected gray voltages to respective ones of the data lines DL of the display panel 100 as data signals.

When the gate signals are sequentially transmitted to the gate lines GL, the data signals are transmitted to the data lines DL in synchronization with the gate signals. When a gate signal is transmitted to a selected gate line, a thin-film transistor TR connected to the selected gate line is turned on (rendered conductive) in response to the gate signal. When a data signal is transmitted to a data line connected to the turned-on thin-film transistor TR, it passes through the turned-on thin-film transistor TR to be charged into the liquid crystal capacitor CLC and the storage capacitor CST of the respective pixel or subpixel. The liquid crystal capacitor CLC adjusts light transmittance of liquid crystals according to the voltage charged therein. When the thin-film transistor TR is turned on, the storage capacitor CST accumulates a data signal. When the thin-film transistor TR is turned off, the storage capacitor CST retains its charge and transmits the corresponding data signal to the liquid crystal capacitor CLC, thereby keeping the liquid crystal capacitor CLC charged and its liquid crystal molecules oriented as indicated by the data signal. In this way, the display panel 100 forms an image that is projected to the user when energized by light from the backlighting unit BLU.

The illustrated light source device BLU includes the light source module 200 and a light source module control unit 300.

The light source module 200 may be disposed adjacent to (e.g., underneath) the display panel 100 so as to provide light to the display panel 100. The light source module 200 may be divided into a plurality of light-emitting blocks B each having individually controllable colored light emitters (e.g., colored LEDs). More specifically, the light source module 200 may be divided into M×N light-emitting blocks B, where M and N are natural numbers. At the same time, the display area (DA) of the display panel 100 may be similarly divided into M×N display blocks DB each underlain by a corresponding one of the light-emitting blocks B. The respective pairs of display block DB and corresponding light-emitting block B may be controlled on a block-by-block basis. More specifically, the light-emitting blocks B may be driven individually according to one or both of a luminance dimming method and a color dimming method. Luminance dimming refers to the case where the full spectrum luminance of each respective light-emitting block B is changed from an originally planned and undimmed state to an altered and post-analysis dimmed state. Color dimming refers to the case where specific portions of the visible spectrum have their respective luminances changed from an originally planned and undimmed color-specific graylevels state to an altered and post-analysis as well as color-specific dimmed state. Dimming may be employed for example, when an originally called for luminance in a specific color-defining spot of a 3D colors coordinates space (u, v and Y) cannot be produced the display device due to its limited gamut capabilities (e.g., it cannot produce the desired color in the u-v plane and/or it cannot produce the desired intensity Y).

FIG. 2 is a schematic plan view of a simplified version of the display panel 100 and of the light source module 200 illustrated in FIG. 1. FIG. 2 may be considered as an enlarged plan view of a portion of the display panel 100 which corresponds to one image block DB and a corresponding one light-emitting block B of the light source module 200.

Referring to FIGS. 1 and 2, each light-emitting block B of the light source module 200 may include a plurality of unit light-emitting blocks 210, and each of the unit light-emitting blocks 210 may include a plurality of primary color emitters such as for example, a first light source 211 which emits light of a first color, a second light source 213 which emits light of a different second color, and a third light source 215 which emits light of a different third color. That is, each light-emitting block B of the light source module 200 may include a plurality of first light sources 211, a plurality of second light sources 213, and a plurality of third light sources 215. For example, the first color may be any one of green, blue and red, the second color may be another one of green, blue and red which is different from the first color, and the third color may be yet another one of green, blue and red which is different from the first and second colors. For ease of description, the first color will hereinafter be defined as red, the second color as green, and the third color as blue. However, this is merely an example, and the first through third colors can vary. Additionally, the each of the unit light-emitting blocks 210 may include a different fourth color (not shown) such as white or yellow, etc.

The first light source 211 may be a semiconductive light-emitting diode (LED). In an exemplary embodiment, the first light source 211 may be a red LED which emits light of the first color, i.e., red light. Likewise, the second light source 213 may be an LED. In an exemplary embodiment, the second light source 213 may be a green LED which emits light of the second color, i.e., green light. In addition, the third light source 215 may be an LED. In an exemplary embodiment, the third light source 215 may be a blue LED which emits light of the third color, i.e., blue light. Red light emitted from the first light source 211 may have a wavelength of, but not limited to, approximately 580 to 700 nm, green light emitted from the second light source 213 may have a wavelength of, but not limited to, approximately 460 to 630 nm, and blue light emitted from the third light source 215 may have a wavelength of, but not limited to, approximately 400 to 500 nm. Alternatively the light sources may use a different light emitting technology such as OLED technology for example.

The unit light-emitting blocks 210 included in each light-emitting block B may correspond to one or more pixels P of the display panel 100. In the drawing, one unit light-emitting block 210 corresponds to four pixels P (to a 2×2 array of such pixels, where each pixel has a respective red subpixel (SPr), a respective blue subpixel (SPb) and a respective green subpixel (SPg). However, this is merely an example, and the unit light-emitting (ULE) blocks 210 may also respectively correspond to individualized ones of the pixels P. That is, a correspondence ratio of one unit light-emitting block 210 and the corresponding one or more pixels P is not limited to a particular ratio (e.g., four pixels per ULE block 210).

A plurality of first light sources 211, a plurality of second light sources 213 and a plurality of third light sources 215 included in one light-emitting block B may be driven independently of those included in others of the light-emitting blocks B. In addition, a plurality of first light sources 211, a plurality of second light sources 213 and a plurality of third light sources 215 included in the same light-emitting block B may be driven independently of each other and each according to its own color. Further, a first light source 211, a second light source 213, and a third light source 215 included in one unit light-emitting block 210 may be driven individually and independently of each other.

Although not illustrated in the drawings, the light source module 200 may further include a circuit board on which the plurality of first light sources 211, the plurality of second light sources 213 and the plurality of third light sources 215 are mounted. Circuit wirings for delivering driving currents to the first light sources 211, the second light sources 213 and the third light sources 215 may be formed on the circuit board. The circuit board may be made of, but not limited to, a printed circuit board (PCB). The circuit board may also be made of, but not limited to, a metal core printed circuit board (MCPCB) in order to improve heat dissipation efficiency.

Referring back to FIG. 1, the light source module control unit 300 is configured to control the respective drivings of each of the light-emitting blocks B of the light source module 200.

The light source module control unit 300 may include an image analysis unit 310, a color coordinate calculation unit 330, an operation unit 350, a mode determination unit 370, and a light source module driving unit 390. Although not shown, it is to be understood that the light source module control unit 300 may include one or more data processors and one or more corresponding memory modules storing instructions and operational data for automatically carrying out the described functions of units 310, 330, 350, 370 and 390.

The image analysis unit 310 may divide the original image signal ID (or the changed image signal ID′) into corresponding signals representing a plurality of image blocks iDB's each corresponding to a respective one of the display panel partitioning blocks DBs and their corresponding light-emitting blocks B. The image analysis unit 310 may generate one or more color dimming signals for controlling the intensities at which colors within each image block DB are to be produced by analyzing the respective image block signals iDB's. For example, the image analysis unit 310 may analyze an image block (hereinafter, referred to as a ‘first image block’) selected from a plurality of image blocks DB, determine a representative color (e.g., MAXr, MAXg, MAXb, and optionally also a MAXw or optionally the most popular among the to be displayed colors in the display block DB) of the first image block based on the analysis result, and generate corresponding color dimming signals for driving the corresponding primary color emitters (e.g., 211, 212, 213) of the respective light-emitting block (hereinafter, referred to as a ‘first light-emitting block’ or image-block-under-analysis) which corresponds to the first image block based on the determined representative color (e.g., most popular color class). More specifics about the operation of generating the color dimming signals using the image analysis unit 310 will be described later.

The image analysis unit 310 may also determine a representative luminance value (e.g., most often repeated gray value irrespective of color, etc.) of the first image block and generate a luminance dimming signal for driving the first light-emitting block based on the representative luminance value.

The color coordinate calculation unit 330 may calculate the ‘used’ color coordinates of each pixel in each image block DB to determine where they place within predetermined color coordinates space (e.g., to thereby define a used gamut portion map). For example, the color coordinate calculation unit 330 may obtain pixel data by analyzing the first image block on a pixel-by-pixel basis and calculate color coordinates (or color dimming color coordinates) of each pixel in a case where color dimming is performed based on the color dimming signal and color coordinates (or non-dimming color coordinates) of each pixel in a case where color dimming is not performed. Here, the color dimming color coordinates (e.g., gamut when color dimming is deployed) and the non-dimming color coordinates (e.g., gamut when color dimming is not deployed) may be color coordinates located in a predetermined color coordinate system such as the 1931 CIE system.

The operation unit 350 may produce data for each pixel. More specifically, for each pixel of the display block DB, the operation unit 350 may calculate a plurality of pixel distortion values and a plurality of pixel improvement values as analysis data for that display block DB. The operation unit 350 may calculate data for each pixel based on the color dimming color coordinates and non-dimming color coordinates of each pixel calculated by the color coordinate calculation unit 330 and determine whether the calculated data for each pixel corresponds to a pixel distortion value or to a pixel improvement value. Here, improvement may relate to an improvement of perceivable color contrast as perceived by the human visual system.

The mode determination unit 370 may determine whether or not to perform color dimming on each light-emitting block B based on the analysis results. In an example, the mode determination unit 370 may receive pixel distortion values and pixel improvement values of the first image block from the operation unit 350 and automatically determine based on these received signals whether or not to perform color dimming on the first light-emitting block, which corresponds to the first image block.

For example, when determining whether or not to perform color dimming on the first light-emitting block (DB1), the mode determination unit 370 may provide a color dimming signal generated by the image analysis unit 310 to the light source module driving unit 390. In addition, if the image analysis unit 310 further generates a luminance dimming signal, the mode determination unit 370 may provide the luminance dimming signal to the light source module driving unit 390 together with the color dimming signal.

When determining not to perform color dimming on the first light-emitting block, the mode determination unit 370 may not provide a color dimming signal generated by the image analysis unit 310 to the light source module driving unit 390. In addition, if the image analysis unit 310 further generates a luminance dimming signal, the mode determination unit 370 may provide only the luminance dimming signal to the light source module driving unit 390. One outcome may be that of reducing power consumption while avoiding excessive distortion of contrast between displayed colors.

The light source module driving unit 390 may drive the light-emitting blocks B of the light source module 200. The light source module driving unit 390 may drive the light-emitting blocks B or the light sources 211, 213 and 215 of the light source module 200 based on one or both of color and luminance dimming signals provided according to the determination result of the mode determination unit 370.

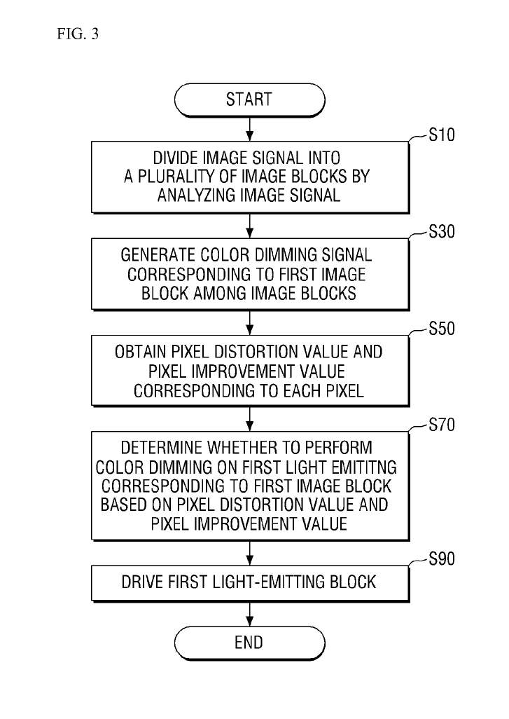

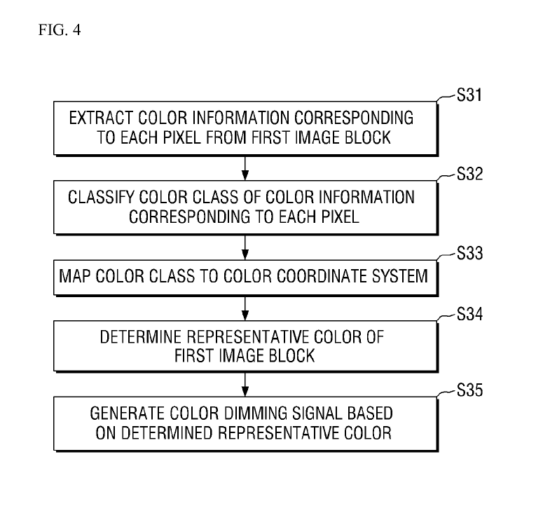

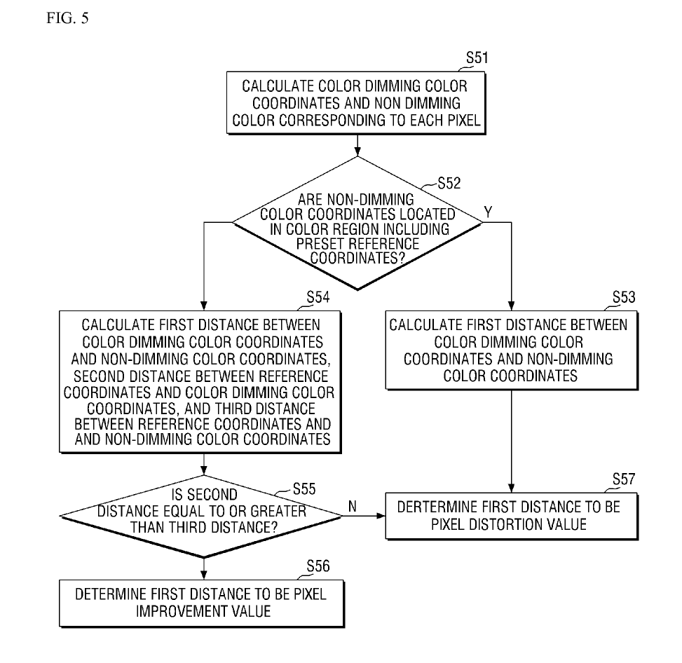

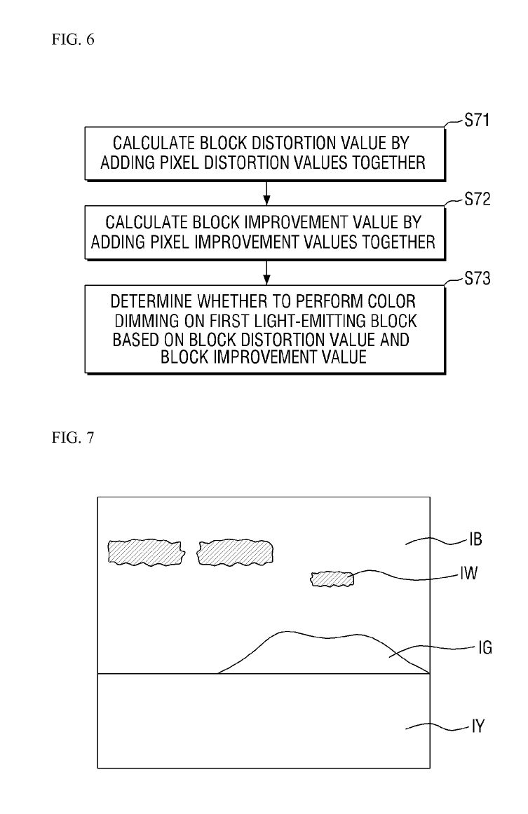

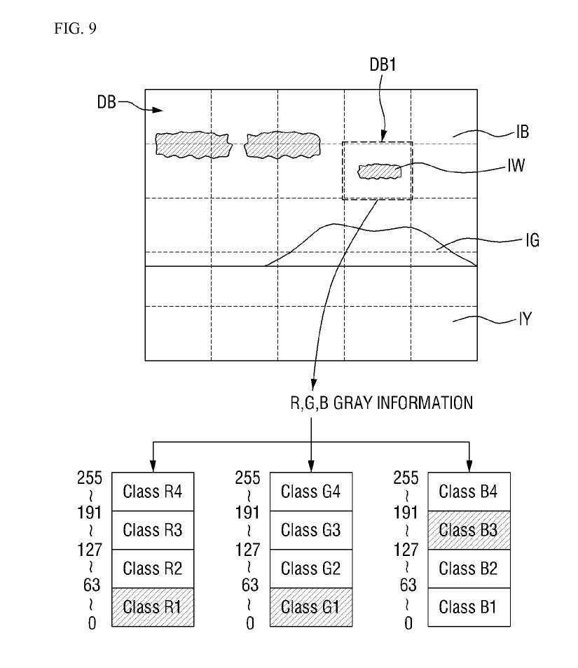

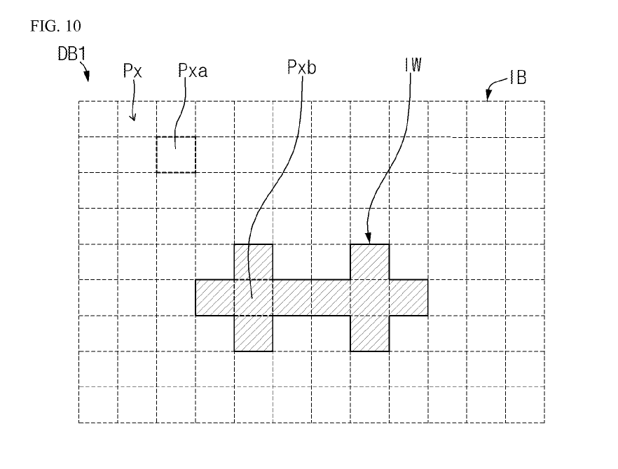

FIG. 3 is a flowchart schematically illustrating a method of driving a light source module according to an embodiment of the present disclosure of invention. More specifically, FIG. 3 is a flowchart schematically illustrating the operation of the light source device BLU of FIG. 1. FIG. 4 is a flowchart schematically illustrating an embodiment of operation S30 included in the driving method of FIG. 3. FIG. 5 is a flowchart schematically illustrating an embodiment of operation S50 included in the driving method of FIG. 3. FIG. 6 is a flowchart schematically illustrating an embodiment of operation S70 included in the driving method of FIG. 3. FIGS. 7 through 14 are diagrams corresponding to the display device 10 of FIG. 1 and provided for explaining the driving method of FIG. 3. In particular, FIG. 10 is an enlarged view of a first image block DB1 illustrated in FIG. 9 where the latter has a blue image region IB, a white image region IW, a green image region IG, and a yellow image region IY.

Referring to FIG. 3, the method of driving a light source module according to the current embodiment may include dividing an image signal into a plurality of image blocks by analyzing the image signal (operation S10), generating a color dimming signal which corresponds to a first image block among the image blocks (operation S30), obtaining a pixel distortion value and a pixel improvement value corresponding to each pixel of the first image block by analyzing the first image block (operation S50), determining whether or not to perform color dimming (or color dimming driving) on a first light-emitting block, which corresponds to the first image block, based on the determined pixel distortion values and pixel improvement values for the first image block (operation S70), and driving the first light-emitting block based on the determination results (operation S90).

The dividing of the image signal into the image blocks by analyzing the image signal (operation S10) may be performed as follows.

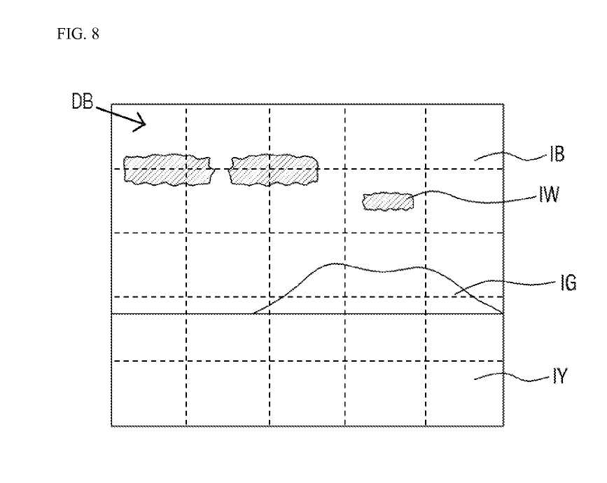

Referring to FIGS. 1 through 3, 7 and 8, when an image signal as illustrated in FIG. 7 is input, the image analysis unit 310 next divides the input image signal into a plurality of same sized image blocks DB as illustrated in FIG. 8 by analyzing the input image signal. For ease of description, it will be assumed that the image signal has four regions with respective and different predominant colors as illustrated in FIGS. 7 and 8. More specifically, the input image (FIG. 7) has a predominantly blue region IB (e.g., background sky where there are more pixels of a blue color than pixels of any other color class), a predominantly white region IW (e.g., clouds in the background sky), a predominantly green region IG (e.g., an areas containing vegetation), and a predominantly yellow region IY (e.g., a sandy foreground).

The generating of the color dimming signal which corresponds to the first image block among the image blocks (operation S30) may be performed as follows.

Referring to FIGS. 1 through 4, 9 and 10, in an exemplary embodiment, operation S30 may include extracting color information corresponding to each pixel from the first image block (operation S31 in flowchart of FIG. 4), classifying a color class of the color information corresponding to each pixel (operation S32) of the analyzed block (e.g., DB1), mapping each color class to a predetermined color coordinate system (operation S33), determining a representative color of the first image block (e.g., which color class has the largest number of pixels belonging to that color class?—operation S34), and generating a color dimming signal based on the determined representative color (operation S35).

More specifically, the light source device BLU or the display device 10 may store preset color class table information, and the color class table information may be stored in a storage unit or the image analysis unit 310. The color class table information may include classifying attribute(s) information for each a plurality of distinct color classes. For example, each of red, green and blue colored points as driven to respective luminances may be associated with respective ones of a predetermined number of discrete color gray levels, e.g., 256 color gray levels per color class, where groups of adjacent and substantially same color gray levels that can hardly be distinguished one from another within the groups and as perceived by the human visual system may be defined as respective color gray classes. In an exemplary embodiment, referring to FIG. 9, each of the red, green and blue color classes may be divided into 256 color gray levels each, and the 256 color gray levels within each color class may be grouped into four color graylevel classes according to visibility. That is, the 256 color gray levels of red, green and blue may be divided into four color graylevel classes, namely and purely as a simple example, Class_X1 covering the gray levels 0 through 63 inclusive, Class_X2 covering the gray levels of 64 to 127, Class_X3 covering the gray levels of 128 to 191 and Class_X4 covering the gray levels of 192 to 255, where X can be one R, G and B. Accordingly, a total of 256×256×256 gray levels (for all permutations of colors R, G, B) and a total of 4×4×4 color graylevel classes (for all permutations of Classes R, G, B) may exist in the current embodiment. In the current embodiment, each of red, green and blue spectral ranges are divided into four corresponding color-specific graylevel classes, more specifically, Class R1 through Class R4, Class G1 through Class G4, or Class B1 through Class B4. However, this is merely an example. That is, since each color-specific graylevel class is defined as a region having the similar or same visibility as perceived by the human visual system, the number of color-specific graylevel classes of each color may vary depending on attributes of the display device. In addition, each color may have equal or different numbers of color-specific graylevel classes, and the size of each color-specific graylevel class may vary according to the number of color gray levels. Further, information about these color classes, that is, the color class table information may be stored in advance in the storage unit or the image analysis unit 310.

The image analysis unit 310 may obtain color information of pixel data Px, which corresponds to each pixel P of the display panel 100, from a first image block DB1 selected arbitrarily or otherwise from the image blocks DB and may identify a color-specific graylevel class of each pixel data Px by comparing the obtained color information with the above-described color class table information. Here, the color information of the pixel data Px may include graylevel information of each of the red, green and blue colors (although in an alternate embodiments, it could other colors or additional colors). Then, the image analysis unit 310 may map the classified color-specific graylevel classes to a color coordinate system divided into a plurality of color regions. In an exemplary embodiment, the color coordinate system may be the CIE 1976 or the CIE 1931 color coordinate system. In addition, in an exemplary embodiment, each of the color regions of the color coordinate system may be defined as a region that includes color gray levels having similar visibility as perceived by the human visual system. The color regions may be provided in a table to form color coordinate system table information. Like the color class table information, the color coordinate system table information may be stored in advance in the storage unit or the image analysis unit 310. Alternatively, the image analysis unit 310 may obtain the color information of the pixel data Px and map the color information directly to the color regions of the color coordinate system without use of the color class classification process.

The image analysis unit 310 may determine a color region within the color coordinate system, where the determined color region is the one which has a largest number of values among color classes mapped to it as part of the color coordinate system, were the color region in the coordinate system having the largest number of values mapped to it from the image-block-under-analysis (e.g., DB1) is deemed to be the “representative color” of that first image block DB1. Alternatively, the image analysis unit 310 may determine the representative color of the first image block DB1 by mapping the one color-specific graylevel class, which has the largest number of values present within the image-block-under-analysis (e.g., DB1), to the color coordinate system. If not performing the color class classification process, the image analysis unit 310 may determine a color region within the color coordinate system, to which the largest number of values are mapped, to be the representative color of the first image block DB1. For example, in the first image block DB1, the number of pixels P corresponding to the blue region IB or the number of pixel data Px corresponding to the blue region IB is larger than the number of pixels P corresponding to the white region IW or the number of pixel data Px corresponding to the white region IW. Therefore, the representative color of the first image block DB1 may be determined to be blue even though the exemplary first image block DB1 of FIGS. 9-10 also includes a white feature (IW, e.g., a white cloud) within its boundaries.

The image analysis unit 310 may generate a color dimming signal based on the determined representative color.

However, the above description is merely an example, and the image analysis unit 310 may also generate the color dimming signal corresponding to the first image block DB1 in various other ways. An aspect of the present disclosure of invention is that the color-specific dimming signal or signals for each image-block-under-analysis (e.g., DB1) are different from the luminance dimming signal or signals where the latter is/are not color-specific and the former are color-specific. Therefore a more nuanced control of the backlight dimming function is provided wherein color-specific attributes of the image-block-under-analysis (e.g., DB1) are accounted for as well as the more generic luminance attributes of the image-block-under-analysis (e.g., DB1). By taking into account the color-specific attributes, an image with less color distortion may be produced and/or less power may be consumed.

In some embodiments, the image analysis unit 310 may generate not only the respective color dimming information but also the respective luminance dimming information for each respective image block (e.g., DB1). For example, the image analysis unit 310 may extract a representative luminance value of the first image block DB1 and generate a luminance dimming signal based on the extracted representative luminance value.

The obtaining of the pixel distortion values and the pixel improvement values corresponding to each of the pixels of the respective image block (e.g., DB1) by analyzing the data of that respective image block (operation S50) may be performed as follows.

Referring to FIGS. 1 through 5 and 10 through 12, in an exemplary embodiment, operation S50 may include calculating color coordinates of the coordinate system that are going to be subject to color dimming and calculating color coordinates of the coordinate system that are non-dimming color coordinates because they are not going to be subject to color dimming by analyzing each pixel of the corresponding first image block (operation S51), determining whether the non-dimming color coordinates are located in a color region including preset reference coordinates (operation S52), calculating a first separation distance within the coordinate system between the color dimming color coordinates and the non-dimming color coordinates if it is determined that the non-dimming color coordinates are located in the color region including the preset reference coordinates (operation S53), and determining if the calculated first distance is a pixel “distortion” value (operation S57). If it is determined in operation S52 that the non-dimming color coordinates are not located in the color region including the preset reference coordinates, the first distance between the color dimming color coordinates and the non-dimming color coordinates, a second distance between the reference coordinates and the color dimming color coordinates, and a third distance between the reference coordinates and the non-dimming color coordinates are calculated (operation S54). Then, it is determined whether the second distance calculated in operation S54 is equal to or greater than the third distance calculated in operation S54 (operation S55). If it is determined in operation S55 that the second distance is equal to or greater than the third distance, the first distance is determined to be a pixel “improvement” value (operation S56). If it is determined in operation S55 that the second distance is less than the third distance, the first distance may be determined to be the pixel “distortion” value (operation S57).

Operation S51 may be performed by the color coordinate calculation unit 330.

More specifically, the color coordinate calculation unit 330 may analyze the first image block DB1 (the image-block-under-analysis) and determine its color dimming color coordinates and its non-dimming color coordinates based on pixel data Px corresponding to each pixel P within the first image block DB1.

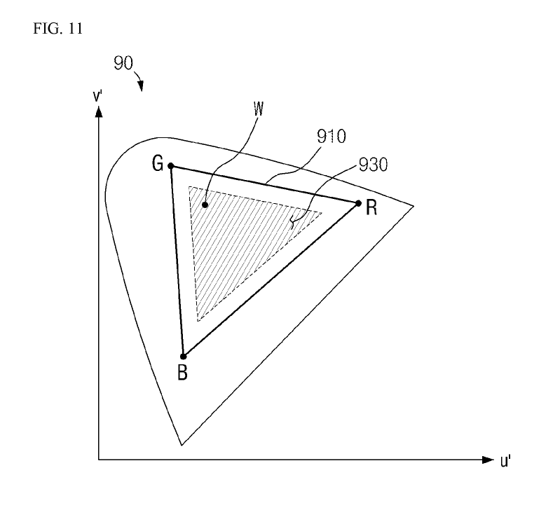

The color dimming color coordinates and the non-dimming color coordinates may be coordinates located in a preset color coordinate system 90 as illustrated in FIG. 11. In an exemplary embodiment, the preset color coordinate system 90 may be the CIE 1976 color coordinate system. The CIE 1976 color coordinate system is advantageous in that a geometric distances between color coordinate points of the 1976 coordinate system are substantially linearly correlated to perception differences between colors as perceived by the human visual system.

A reference region 910, a reference coordinates point W, and a determination region 930 may be defined in the preset color coordinate system 90 as illustrated in FIG. 11.

The reference region 910 (a.k.a. reproducible gamut region) may be a color region that can be expressed by the display device 10 when the latter is not constrained (e.g., power limited) do it performing dimming (or in other words, when it performs non-dimming). Alternatively, the reference region 910 may be a National Television System Committee (NTSC) reference color region.

The reference coordinates point W may be a white point at which red, green and blue gray values are equal. In other words, the reference coordinates point W may be color coordinates of white as produced by the specific display device when its R, G, B light sources are driven by equal graylevels.

The determination region 930 is smaller than and inside the reference region 910 (the device-producible gamut region) and this determination region 930 may be used as one criterion for calculating pixel improvement values and pixel distortion values. The determination region 930 is structured to include the reference coordinates point W. It is also structured to drive the R, G, B light sources of the display device less intensely than is possible within the larger boundaries of the reference region 910 (the device-producible gamut region). In other words, if the boundaries of the determination region 930 are not violated, there will be no fully saturated R, G or B pixel, but on the other hand, the luminance energies of the image will be more evenly distributed among the R, G, B light sources and power may be better conserved while the human visual system does not readily perceive this slight deviation from the originally intended image. More specifically, if the pixel data of the image-block-under-analysis (e.g., DB1) has Rg as an included red gray value, Gg as an included green gray value, and Bg as an included blue gray value, the determination region 930 may be defined as a region that satisfies the constraining conditions of all of Equations (1) through (3):

|Rg−Gg|≦C1, (1)

|Gg−Bg|≦C2, (2)

|Bg−Rg|≦C3, (2)

where C1 through C3 may each have an integer value picked from the range of 0 to 255 but not all can be 255. In other words, allowed differences between the color-specific graylevels are caused to be less severe by reducing one or more of the C1, C2 and C3 constants below 255.

That is, the determination region 930 may be a region satisfying a condition that an absolute value of a difference between the red gray value and the green gray value should be equal to or less than a first set value of C1, a condition that an absolute value of a difference between the green gray value and the blue gray value should be equal to or less than a second set value of C2, and a condition that an absolute value of a difference between the blue gray value and the red gray value should be equal to or less than a third set value of C3. Here, the first through third set values can be changed individually within a range of 0 to 255 but not all can be 255 at the same time. The definition of the determination region 930 may be preset and stored in the display device 10 or the light source device BLU.

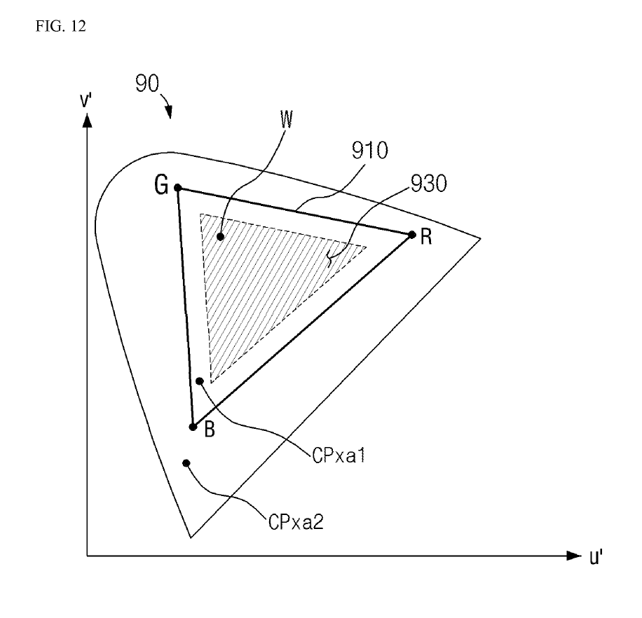

Of a plurality of pixel data items Px illustrated in FIG. 10, pixel data located in the blue region IB (e.g., blue sky background) may be defined as first pixel data Pxa. In this case and referring to FIG. 12, the color coordinate calculation unit 330 may determine which bluish pixels within the image-block-under-analysis (e.g., DB1) are non-dimming color coordinates CPxa1 (spot CPxa1) not in need of dimming and which bluish pixels within the image-block-under-analysis (e.g., DB1) are color dimming color coordinates CPxa2 (spot CPxa2) in need of dimming where this information is obtained from the first pixel data items Pxa (e.g., blue sky pixels) and placed in the color coordinate system 90 as illustrated in FIG. 12. In an exemplary embodiment, since the representative color of the first image block DB1 is determined to be blue as described above, the color dimming color coordinates CPxa2 of the first pixel data Pxa may be located relatively closer to the saturated blue point (B) of the display device gamut 910 than the non-dimming-worthy color coordinates CPxa1. Additionally, since the dimming-worthy color coordinates CPxa2 spots are located outside the display device's reference region 910 (the device-producible gamut region) as illustrated in FIG. 12, those points must be transformed (for example dimmed) in order for their respective luminances to become producible by the gamut limited (910) display device.

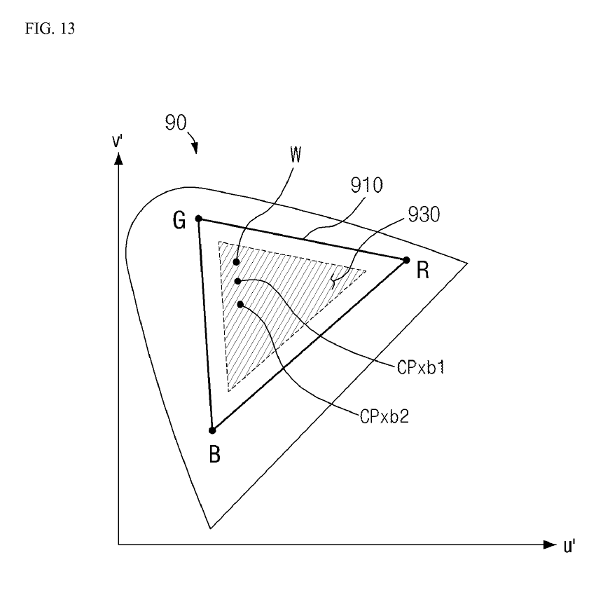

Likewise, of the pixel data Px illustrated in FIG. 10 (that of DB1 taken alone), pixel data located in the white region IW of the image-block-under-analysis (e.g., DB1) may be defined as second pixel data Pxb. In this case and referring to FIG. 13, the color coordinate calculation unit 330 may determine presence of non-dimming color coordinates CPxb1 and of color dimming color coordinates CPxb2 of the second pixel data Pxb in the color coordinate system 90 as illustrated in FIG. 13. In the exemplary embodiment, since the representative color of the first image block DB1 has been determined to be blue as described above, and since the color dimming color coordinates CPxb2 of the second pixel data Pxb are located relatively closer to blue (B) than to white (W) while the non-dimming color coordinates CPxb1 are closer to white (W), the color dimming color coordinates CPxb2 may be moved so as to be closer to white (W) while not perceptively changing what the human visual system sees and while at the same time achieving a desired improvement in the to be displayed image such as improving contrast and/or reducing power consumption.

Operations S52 through S57 described above may be performed by the operation unit 350.

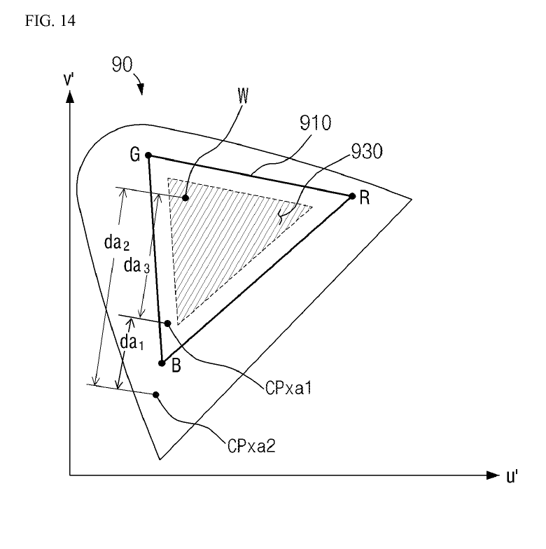

Specifically, referring to FIG. 14, the operation unit 350 first determines whether the non-dimming color coordinates CPxa1 of the first pixel data Pxa calculated by the color coordinate calculation unit 330 are located in the predefined determination region 930. Since the non-dimming color coordinates CPxa1 of the first pixel data Pxa are located outside the determination region 930 as illustrated in FIG. 14, the operation unit 350 calculates a first distance da1 between the color dimming color coordinates CPxa2 and the non-dimming color coordinates CPxa1. In addition, the operation unit 350 calculates a second distance da2 between the reference coordinates point W and the color dimming color coordinates CPxa2 and a third distance da3 between the reference coordinates point W and the non-dimming color coordinates CPxa1. The operation unit 350 determines whether the second distance da2 is equal to or greater than the third distance da3. If it is determined that the second distance da2 is equal to or greater than the third distance da3 (da2≧da3), the operation unit 350 determines the first distance da1 to be a pixel “improvement value”. On the other hand, if it is determined that the second distance da2 is less than the third distance da3 (da2<da3), the operation unit 350 determines the first distance da1 to be a pixel “distortion” value. In the given exemplary embodiment, since the second distance da2 is greater than the third distance da3 in FIG. 14, the operation unit 350 determines the first distance da1 to be a pixel improvement value for the first pixel data Pxa.

Coordinates located outside the determination region 930 are places where a difference among red, green and blue gray values is more distinct to the human visual system. Thus, strong color characteristics are exhibited. If color dimming is applied on pixel data having these out-of-region-930 coordinates, and if the color dimming color coordinates are thereby shifted closer to the relatively colorless reference coordinates point W, the distinctive color characteristics will be reduced by the color dimming operation. Therefore, such a distance difference (relative to white W) between color dimming color coordinates and non-dimming color coordinates is determined to be a pixel distortion value. On the other hand, if color dimming is performed, and if the involved color dimming color coordinates are shifted in a direction away from the (relatively colorless) reference coordinates point W, the distinctive color characteristics are increased (are made more vivid) by the planned color dimming. Therefore, in the latter case, the distance between the color dimming color coordinates and the non-dimming color coordinates is determined to be a pixel “improvement” value.

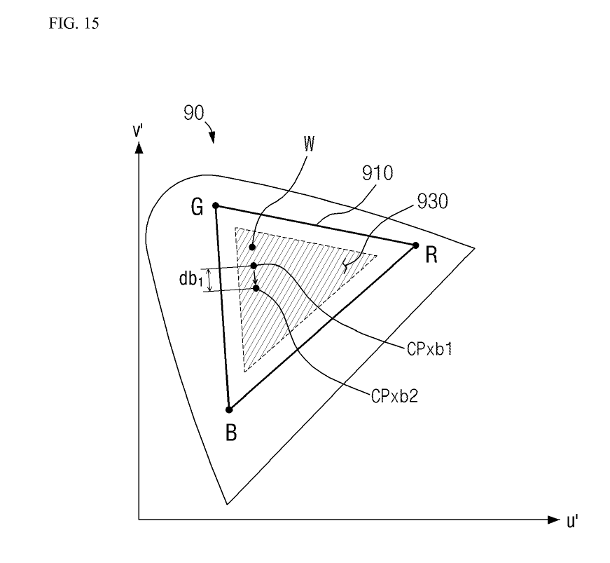

Likewise, referring to FIG. 15, the operation unit 350 determines whether the non-dimming color coordinates CPxb1 of the second pixel data Pxb calculated by the color coordinate calculation unit 330 are located in the determination region 930. Since the non-dimming color coordinates CPxb1 of the second pixel data Pxb are located inside the determination region 930 as illustrated in FIG. 15, the operation unit 350 calculates a first distance db1 between the color dimming color coordinates CPxb2 and the non-dimming color coordinates CPxb1. In addition, the operation unit 350 determines the first distance db1 to be a pixel distortion value for the second pixel data Pxb since moving the CPxb2 spot closer to the relatively colorless, reference coordinates point W will reduce color distinctiveness.

As mentioned, coordinates located inside the determination region 930 are considered to be places where the difference among the red, green and blue gray values is not color-wise distinct. Thus, weak color characteristics are exhibited, and these coordinates are relatively closer to the white coordinates point (W) than are the coordinates outside of determination region 930. If color dimming is performed on pixel data having these outside-930 coordinates, color distortion is highly likely to occur in an image displayed on the display panel 100. Therefore, if non-dimming color coordinates are located inside the determination region 930, a distance between color dimming color coordinates and the non-dimming color coordinates is determined to be a pixel distortion value.

The determining of whether to perform color dimming (or color dimming driving) on the first light-emitting block, which corresponds to the first image block, based on the determined pixel distortion values and the determined pixel improvement values (operation S70) may be performed as follows.

Referring to FIGS. 1 through 6 and 16, in an exemplary embodiment, operation S70 may include calculating a block distortion value by adding together the pixel distortion values of the block (operation S71), calculating a block improvement value by adding together the pixel improvement values of the block (operation S72), and determining whether to perform color dimming (or color dimming driving) on the first light-emitting block based on the block distortion value and based the block improvement value (operation S73). Operations S71 and S72 may be performed in a reverse order or simultaneously.

Operation S70 described above may be performed by the mode determination unit 370.

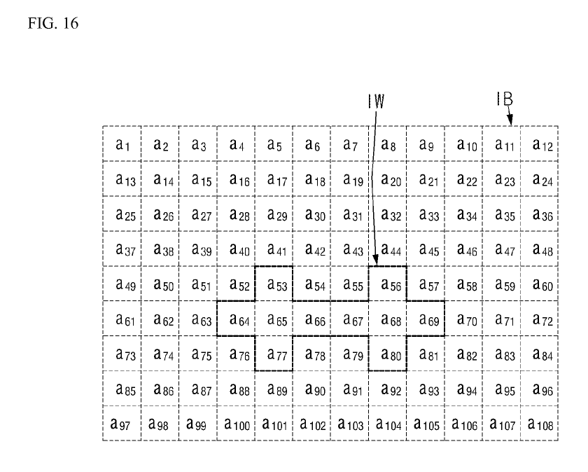

FIG. 16 is a matrix showing a value obtained for each pixel data Px of the first image block DB1 of FIG. 10. It will be assumed that the calculation unit 350 has determined obtained values corresponding to the white region IW of FIG. 10 to be pixel distortion values and obtained values corresponding to the blue region IB of FIG. 10 to be pixel improvement values.

The mode determination unit 370 sums the respective improvement and distortion values and thus calculates a total block improvement value and a total block distortion value by respectively adding the pixel improvement values and the pixel distortion values together. For example, if the block improvement value is Ba and the block distortion value is Bd, the mode determination unit 370 may calculate Ba and Bd. Here, Ba may have a value obtained by adding up a1 through a52, a54, a55, a57 through a63, a70 through a76, a78, a79 and a81 through a108. Likewise, Bd may have a value obtained by adding up a53, a56, a64 through a69, a77 and a80.

The mode determination unit 370 determines whether to perform color dimming on a first light-emitting block (B1), which corresponds to the first image block DB1 of the light source module 200, based on the block distortion value Bd and based on the block improvement value Ba.

In an exemplary embodiment, if the block distortion value Bd is greater than the block improvement value Ba, the mode determination unit 370 may determine not to perform the planned color dimming on the first light-emitting block. Accordingly, the mode determination unit 370 may not provide a color dimming signal for the first light-emitting block generated by the image analysis unit 310 to the light source module driving unit 390. If the image analysis unit 310 further generates a luminance dimming signal, the mode determination unit 370 may provide only the luminance dimming signal for the first light-emitting block to the light source module driving unit 390.

In an exemplary embodiment, if the block distortion value Bd is less than the block improvement value Ba, the mode determination unit 370 may determine to perform color dimming on the first light-emitting block. Accordingly, the mode determination unit 370 may provide the color dimming signal or signals for the first light-emitting block generated by the image analysis unit 310 to the light source module driving unit 390. If the image analysis unit 310 further generates a luminance dimming signal, the mode determination unit 370 may provide both the color dimming signal and the luminance dimming signal for the first light-emitting block to the light source module driving unit 390.

However, the above description is merely an example, and the determination criterion of the mode determination unit 370 can vary. For example, the mode determination unit 370 may generate values by giving a weight to at least any one of the block distortion value Bd and the block improvement value Ba and determine whether to perform color dimming on the first light-emitting block based on the generated values. That is, the determination criterion of the mode determination unit 370 can vary appropriately as necessary, and the scope of the present disclosure of invention is not limited to the above exemplary embodiment.

More specifically, in accordance with one embodiment, pixel distortion values and pixel improvement values for each of the pixels in a image-block-under-analysis (e.g., DB1) are obtained before a planned color-specific dimming operation is carried out, and based on the obtained pixel distortion values and pixel improvement values, it is determined whether to actually perform or not the planned color-specific dimming driving. Therefore, the amount of color distortion (e.g., reduction of color contrast or distinctiveness) that can occur due to a planned color-specific dimming can be avoided or reduced.

Further, whether to perform color dimming driving is determined by considering color information of each pixel within the image-block-under-analysis (e.g., DB1). Therefore, it is possible to reduce color distortion and improve color reproducibility as compared with a case when color dimming driving is performed without the determination process. Accordingly, the display quality of a display device can be improved.

Embodiments in accordance with the present disclosure of invention can provide at least one of the following advantages.

They can provide a method of driving a light source module which can improve display quality and/or reduce power consumption.

They can provide a method of driving a light source module which can improve color reproducibility and reduce color distortion.

However, the advantageous effects of embodiments in accordance with the present disclosure of invention are not restricted to the one set forth herein. The above and other effects of the present teachings will become more apparent to one of daily skill in the art after closer review of the present teachings.

While the present disclosure of invention has been particularly shown and described with reference to exemplary embodiments thereof, it will be understood by those of ordinary skill in the art in light of the foregoing that various changes in form and detail may be made therein without departing from the spirit and scope of the present teachings. The exemplary embodiments should be considered in a descriptive sense only and not for purposes of limitation.

What is claimed is:

1. A method of driving a light source module, which provides light to a display panel having a plurality of pixels and comprises a plurality of light-emitting blocks, on a light-emitting block-by-light-emitting block-basis, the method comprising:
dividing an image signal into a plurality of image blocks corresponding to the light-emitting blocks by analyzing the image signal;
generating a color dimming signal which corresponds to a first image block among the image blocks;
obtaining a pixel distortion value and a pixel improvement value corresponding to each pixel by analyzing the first image block;
determining whether to perform color dimming on a first light-emitting block, which corresponds to the first image block, based on the pixel distortion value and the pixel improvement value; and
driving the first light-emitting block based on the determination result.

2. The method of claim 1, wherein the obtaining of the pixel distortion value and the pixel improvement value comprises:
calculating color dimming color coordinates and non-dimming color coordinates, which correspond to each pixel, in a predetermined color coordinate system by analyzing the first image block; and
calculating the pixel distortion value and the pixel improvement value based on the color dimming color coordinates and the non-dimming color coordinates.

3. The method of claim 2, wherein the predetermined color coordinate system is CIE 1976.

4. The method of claim 3, wherein the calculating of the pixel distortion values and of the color improvement values includes determining whether the non-dimming color coordinates are located inside a predefined determination region having preset reference coordinates within the color coordinate system.

5. The method of claim 4, wherein the reference coordinates are coordinates at which a red gray value, a green gray value, and a blue gray value are equal to one another.

6. The method of claim 4, wherein the determination region is a region satisfying a condition that an absolute value of a difference between the red gray value and the green gray value should be equal to or less than a first set value, a condition that an absolute value of a difference between the green gray value and the blue gray value should be equal to or less than a second set value, and a condition that an absolute value of a difference between the blue gray value and the red gray value should be equal to or less than a third set value.

7. The method of claim 4, wherein the calculating of the pixel distortion values and the pixel improvement values further comprises:
if it is determined that the non-dimming color coordinates are located within the determination region:
calculating a first distance between the color dimming color coordinates and the non-dimming color coordinates; and
determining the first distance to be a pixel distortion value.

8. The method of claim 4, wherein the calculating of the pixel distortion value and the pixel improvement value comprises, if it is determined that the non-dimming color coordinates are not located in the determination region:
calculating a first distance between the color dimming color coordinates and the non-dimming color coordinates, a second distance between the reference point and the color dimming color coordinates, and a third distance between the reference point and the non-dimming color coordinates;
determining the first distance to be a pixel improvement value if the second distance is equal to or greater than the third distance; and
determining the first distance to be a pixel distortion value if the second distance is less than the third distance.

9. The method of claim 1, wherein the determining of whether to perform color dimming on the first light-emitting block based on the pixel distortion values and the pixel improvement values comprises:
calculating a block distortion value of the first image block by adding together the pixel distortion values;
calculating a block improvement value of the first image block by adding together the pixel improvement values; and
determining whether to perform color dimming on the first light-emitting block based on the block distortion value and on the block improvement value.

10. The method of claim 1, wherein each of the light-emitting blocks comprises one or more unit light-emitting blocks, wherein each of the unit light-emitting blocks comprises a first light source which emits light of a first color, a second light source which emits light of a second color, and a third light source which emits light of a third color.

11. A display device comprising:
a light source module which comprises a plurality of light-emitting blocks;
a display panel which comprises a plurality of pixels and is divided into a plurality of image display blocks corresponding to respective ones of the lights-emitting blocks;
a light source module control unit which is configured to divide a supplied image signal into a plurality of image blocks each corresponding to a respective one of the image display blocks, to generate a color dimming signal corresponding to a first image block among the image blocks, to determine pixel distortion values and pixel improvement values corresponding to each of pixels in an image-block-under-analysis by analyzing the pixels of the first image block, to determine whether to perform color dimming or not on a drive signal of a first light-emitting block corresponding to the first image block based on the pixel distortion values and on the pixel improvement values, and to drive the first light-emitting block based on the determination result.

12. The display device of claim 11, wherein each of the light-emitting blocks comprises one or more unit light-emitting blocks, wherein each of the unit light-emitting blocks comprises a first light source which emits light of a first color, a second light source which emits light of a second color, and a third light source which emits light of a third color.

13. The display device of claim 11, wherein the light source module control unit comprises:
an image analysis unit configured to divide the image signal into the image blocks by analyzing the image signal and to generate the color dimming signal by analyzing the first image block among the image blocks;
a color coordinate calculation unit configured to calculate color dimming color coordinates and non-dimming color coordinates corresponding to each pixel in a predetermined color coordinate system by analyzing the first image block;
an operation unit configured to calculate the pixel distortion values and the pixel improvement values based on the color dimming color coordinates and the non-dimming color coordinates;
a mode determination unit configured to determine whether to perform color dimming on the first light-emitting block based on the pixel distortion values and the pixel improvement values; and
a light source module driving unit configured to drive each light-emitting block of the light source module based on the determination result of the mode determination unit.

14. The display device of claim 13, wherein the predetermined color coordinate system is CIE 1976.

15. The display device of claim 14, wherein the operation unit determines whether the non-dimming color coordinates are located in a predefined determination region having preset reference coordinates in the color coordinate system.

16. The display device of claim 15, wherein the reference coordinates are coordinates at which a red gray value, a green gray value, and a blue gray value are equal to one another.

17. The display device of claim 15, wherein the determination region is a region satisfying a condition that an absolute value of a difference between the red gray value and the green gray value should be equal to or less than a first set value, a condition that an absolute value of a difference between the green gray value and the blue gray value should be equal to or less than a second set value, and a condition that an absolute value of a difference between the blue gray value and the red gray value should be equal to or less than a third set value.

18. The display device of claim 15, wherein when determining that the non-dimming color coordinates are located in the determination region, the operation unit calculates a first distance between the color dimming color coordinates and the non-dimming color coordinates and determines the first distance to be the pixel distortion value.

19. The display device of claim 15, wherein when determining that the non-dimming color coordinates are not located in the determination region, the operation unit calculates a first distance between the color dimming color coordinates and the non-dimming color coordinates, a second distance between the reference coordinates and the color dimming color coordinates, and a third distance between the reference coordinates and the non-dimming color coordinates, determines the first distance to be the pixel improvement value if the second distance is equal to or greater than the third distance, and determines the first distance to be the pixel distortion value if the second distance is less than the third distance.

20. The display device of claim 11, wherein the mode determination unit calculates a block distortion value of the first image block by adding the pixel distortion values together, calculates a block improvement value of the first image block by adding the pixel improvement values together; and determines a dimming driving mode of the first light-emitting block based on the block distortion value and the block improvement value.
